(19) United States
(12) Patent Application Publication
(10) Pub. No.: US 2020/0081245 A1
(43) Pub. Date: Mar. 12, 2020

(54) SYSTEM AND METHOD FOR CHARACTERIZING MULTI-LAYERED FILM STACKS

(71) Applicant: Amit Deliwala, Andover, MA (US)

(72) Inventor: Amit Deliwala, Andover, MA (US)

(21) Appl. No.: 16/125,425

(22) Filed: Sep. 7, 2018

(51) Int. Cl. G02B 27/00; G02B 5/28; G06F 17/50

(52) U.S. Cl. CPC G02B 27/0012; G06F 17/50; G02B 5/282

(57) ABSTRACT

A system and method are provided for designing, optimizing or characterizing multi-layered thin film stacks. The system and method employ multi-core or multi-processor architectures such as those in graphical processing units (GPU) that are capable of efficient and parallel computation of matrix data representing parameters and variables of the thin film stack. Previously-unattainable solution sets are rapidly developed to study the geometric and performance characteristics of thin film stacks, especially non-traditional film stacks that would otherwise be difficult or impossible to design or study.

### TECHNICAL FIELD

The present application relates to the design and characterization of thin films having a plurality of layers therein, and especially to the use of certain processing techniques for optimizing the same.

### BACKGROUND

Thin multi-layered films are used in a variety of applications including electromagnetics, optics, acoustics and even thermodynamics. The design of a multi-layered film depends on its intended use, the properties of the radiation or energy passing therethrough, and other factors. Thin films are used in optical coatings, building materials, imaging systems, displays and other applications. A film stack can incorporate several or dozens of thin stacked layers that contribute to the overall behavior of the stack. The characteristics of a given film stack are affected by the nature of its individual layers such as each layer's thickness and material composition, e.g., its density, impedance, index of refraction, etc. The nature of a multi-layered film stack needs to be understood at least in the relevant wavelength or energy bands of interest, and including the film's spectral distribution of reflectance, transmittance, and absorption (RTA) along such spectrum.

Common textbook methods for designing multi-layer film stacks are limiting, and other more optimal designs often exist but their implementation is frustrated by a lack of formal or empirical systems and methods for testing and characterizing thin film stacks, especially novel or non-traditional designs. In such situations a simulation or iterative computational methods might be useful in determining a best approach to a thin film stack for a particular application, e.g., using a transfer matrix method (TMM) that applies matrix operations at the various layer interfaces. Traditional techniques are especially limiting in designing and characterizing uncommon types of film stacks. Traditional methods for calculating the performance of such stacks are computationally inefficient, especially using common central processing unit (CPU) hardware. Moreover, the use of common CPUs to perform simulation and testing and characterization of a complex film structure is limited by the nature of the CPU architecture and required programming methods suitable for the CPU architecture. Using prior techniques, thousands or millions of solutions may be required to analyze to arrive at optimal solutions. Prior CPU-based computing methods and tools (hardware and software) require relatively long computation times to characterize a given complex film stack. This disclosure addresses limitations of the prior systems and methods for designing and/or characterizing unique multi-layered thin film stacks.

### SUMMARY

Example embodiments described herein have innovative features, no single one of which is indispensable or solely responsible for their desirable attributes.

In some aspects, the present system and method allow efficient determination of the characteristics of thin-films by running the transfer-matrix method-based simulations on a graphical processor unit (GPU). The object is met, according to an embodiment of the present invention, by a method of performing a thin-film simulation using a GPU.

In one or more embodiments, the transfer-matrix method based thin-film simulations can be organized in a way that is amenable to processing by a GPU. This is accomplished by transforming the problem from a sequential problem of calculating at each of the wavelengths, angle of incidence (A01), and polarization to a parallel problem that is suited to the GPU. In one aspect of the invention, the transformation is accomplished by allocating the computation of film characteristics at different wavelengths to different cores of the GPU. In another aspect of the invention, the transformation is accomplished by allocating the computation of film characteristics at different angles to different cores of the GPU. In yet another aspect of the invention, the transformation is accomplished by allocating the computation of film characteristics at different polarizations to different cores of the GPU. These above methods can also be combined so that parallelization is achieved by having different cores of the GPU compute a unique combination of polarization, wavelength and angle. These are simply examples and represent some, but not all the ways that thin-film simulations can be arranged in a way that is amenable to GPU computation.

One or more embodiments are directed to a system for automated characterization of a multi-layered thin film stack, comprising a graphics processing unit (GPU) having a plurality of processor cores each configured and arranged to execute machine-readable instructions in parallel; a data store, coupled to said GPU, having addressable storage locations encoding parameters describing a plurality of individual films in said film stack; and a feedback controller configured and arranged to control a layer deposition process that adds layers to said film stack.

One or more embodiments are directed to a method for characterizing a multi-layer thin film stack using parallel processing computations in a multi-core graphics processing unit (GPU), the method comprising loading a plurality of data sets into respective memory locations of a data store, each data set corresponding to a layer of said multi-layer thin film stack, said plurality of data sets including data corresponding to respective material properties of said layers and further including data corresponding to respective geometric parameters of said layers; executing in parallel, in each of a plurality of said GPU cores, machine-readable instructions encoding a transfer matrix method (TMM), and taking as inputs said plurality of data sets; and using said GPU cores to generate outputs corresponding to one or more characteristics of said thin film stack.

Those skilled in the art will appreciate the scope of this disclosure and invention is not limited to the examples and embodiments illustrated in particular detail, but also encompasses any reasonable scope of equivalent embodiments.

### BRIEF DESCRIPTION OF THE DRAWINGS

For a fuller understanding of the nature and advantages of the present concepts, reference is made to the following detailed description of preferred embodiments and in connection with the accompanying drawings, in which:

FIG. 1 illustrates an exemplary multi-layer film with alternating layers of high-refractive index material and low-refractive index material, and depicts the relationship between the film stack parts and the matrix algebra pertaining thereto;

FIG. 2 illustrates an exemplary architecture that abstracts a GPU hardware into an organized software platform;

FIG. 3 illustrates an exemplary process for performing thin-film simulations on a GPU;

FIG. 4 illustrates an exemplary plot of various spectra found by optimization via CPU and GPU based thin film simulation methods;

FIG. 5 is an illustrative table showing the film stacks designed by GPU-based and CPU-based optimization algorithms; and

FIG. 6 illustrates components of a system according to embodiments of the present disclosure and for performing the present methods.

### DETAILED DESCRIPTION

As discussed above, the way in which multi-layered thin film stacks are traditionally designed and characterized is inefficient and does not lend itself to complex or novel configurations, at least not without undue computational effort. This and other shortcomings of the prior art are addressed in the disclosure below, which includes exemplary preferred embodiments provided by way of illustration. The present disclosure therefore provides needed or desired solutions for the above-referenced problems and is especially useful when used to analyze complex user-defined stacks and stacks of a non-traditional nature.

In an aspect of the present invention, multi-layered film solutions are analyzed using highly parallelizable methods. In another aspect these parallelizable solutions are implemented in a graphical processor unit (GPU) rather than conventional CPU to leverage the efficiencies of GPU-based parallel processing in the design and analysis of complex film stacks. In particular aspects, a multi-core GPU architecture can be used to implement the present system and method.

While not limited to the analysis of optical or electromagnetic systems, the present system and method can be used, inter cilia, to design and study and optimize multi-layered optical thin film stacks. For instance, the calculation of the RTA for the propagation of electromagnetic (e.g., light) waves through a user-defined film stack can be done by using the continuity conditions for the electric and magnetic field at the boundary of two adjacent films in the film stack. The user defined film stack may be considered a list of multiple layers or films of different materials that have different impedance and have specific thickness. The transfer-matrix method (TMM) is a convenient method that reduces this calculation to a series of matrix operations. In what follows, we focus on the electromagnetic properties of thin films, but the innovation and the method described here can be extended to other wave phenomena. For a given film stack, one is usually interested in calculating RTA vs wavelength, angle of incidence, and polarization as well as internal field distributions for optimizing absorption and other physical phenomena that depend on electric and magnetic fields. In TMM, for each user defined film stack a series of matrices must be computed and multiplied to derive a single reflectance, transmittance or absorbance at each of the wavelengths, angles of incidence, and polarization If necessary, the TMM also allows one to compute internal electric and magnetic fields in the film-stack.

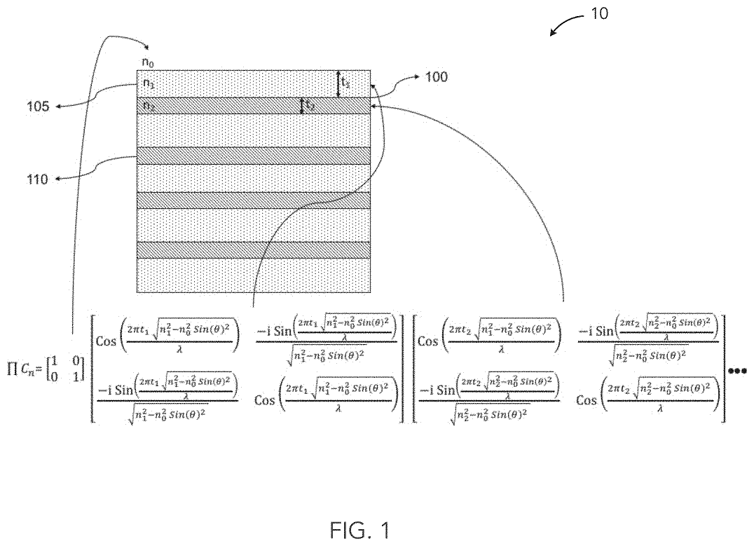

FIG. 1 illustrates an exemplary multi-layered thin film stack 10. Exemplary film stack 10 is based on a high-low alternating stack design. The high-refractive index material 105 and the low-refractive index material 110 alternate. An example of materials that could be used are TiO₂ for the high-index material and SiO₂ for the low index material. For each boundary between films, a characteristic matrix is calculated via the Fresnel equations, given the incident angle and refractive indices of each of the layers. These refractive indices can be given as complex values to account for absorption within a layer.

$${C}_{n} = [ \begin{matrix}{t}_{n , n + 1} {e}^{- iOPL} & {r}_{n , n + 1} {e}^{- iOPL} \\ {r}_{n , n + 1} {e}^{iOPL} & {t}_{n , n + 1} {e}^{iOPL}\end{matrix} ]$$

The n-th boundary matrix is formed by calculating the Fresnel coefficient and multiplying by the complex phase related to the optical path length (OPL) in the media, given by the thickness and refractive index of the material as well as the incident angle and wavelength of light. For an n-layer film, there are n+1 matrices, as the boundaries between the incident medium and substrate also are included in the matrix formalism. To calculate the characteristics of the film stack, the complex matrices are multiplied together. The elements of the resulting matrix can be manipulated to form complex reflection and/or transmission coefficients, or used to find reflectance, transmittance and/or absorbance. While some existing TMM software solutions exist, these are limited to CPU-based calculation and do not organize calculation in a way that is amenable to highly parallelized computing. Both the system and the method of the present invention provide notable engineering and economic advantages over prior solutions.

The present series of matrix operations is valid for finding the characteristics for a single permutation of wavelength, film materials, film thicknesses, incident angle and polarization. Practically in film simulation, it is necessary to calculate characteristics over a wide range of wavelengths, angles and across multiple polarizations. For applications in film design, it may be useful to test multiple film thicknesses or materials, which would greatly increase the number of these operations. For example, if a thin-film designer would like to optimize a film across a 1000 nm bandwidth, and would like characteristics of the film every 1 nm, this would could be a total of 2 Polarizations*5 angles*1000 wavelengths*n+1 layers. For a 9-layer film as shown in FIG. 1, this would be 100000 matrices that need to be multiplied to form a reflectance or transmittance curve for a single film of a stack of pre-chosen materials and thicknesses. A typical optimization process, even if one keeps the material set the same, requires one to vary thicknesses of all the stacks. One may use some heuristic to make each layer variation not independent to reduce the number of trials—such as make all high index stacks vary together—but by doing this one has often severely limited the number of possible solutions that may be achievable for the same material stack. In practice, this often forces the designer to increase the number of layers in the stack to achieve the required spectral transmittance or reflectance. Those skilled in the art will appreciate that the illustrations and quantitative examples provided herein are not limiting of the scope of use and implementation of the present invention.

The large number of computations required for a single film stack material and thickness combination lends itself well to GPU computing. As the calculations for each angle, wavelength and polarization are independent of one another, they can be parallelizable and therefore save runtime. By utilizing all the available cores of a GPU and efficient memory management, it is possible to achieve a massive speed-up relative to traditional sequential CPU computing.

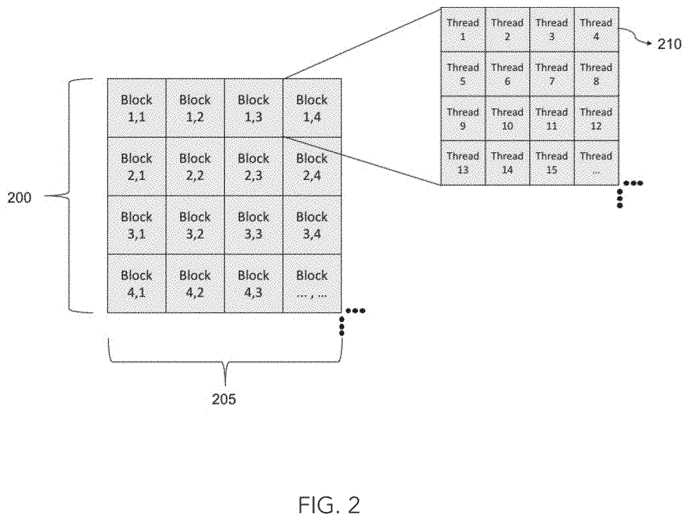

FIG. 2 illustrates an exemplary architecture for the present system and method. For NVIDIA processors, a software compute platform has been developed by NVIDIA named CUDA which abstracts the GPU hardware into an organized software platform that allows writing code that runs on an NVIDIA GPU. In this parallel computing platform, a kernel is a function that runs on multiple cores of the GPU in parallel, but on different data. A thread is a single instance of a kernel, and a three-dimensional grid of threads can be launched at once, called the block. A 2-dimensional example of this grid of blocks is shown in FIG. 2. The dimensions of the grid 200, 205 can be chosen arbitrarily given that they meet the constraints of the CUDA software architecture and can be chosen to optimally fit the hardware being used. Each block can spawn up to thirty-two threads. For thin-film simulations, each boundary matrix must be calculated given the refractive indices of the materials, the incident angle, the thicknesses of each layer and the wavelength and polarization of light. One way to organize this in CUDA is by loading all the above data into GPU memory and then assigning a different thread 210 to each matrix.

Each matrix's values are calculated according to the Fresnel equations in parallel. If there are more matrices than cores, the calculation is queued, so when a physical core finishes its computation, the next queued instance of the kernel is launched on that core. Once the matrices have all been calculated, they must be multiplied in groups of n+1 layers. This is because for a unique combination of angle, wavelength and polarization, there is a set of n+1 matrices. This operation can also be computed in parallel in a similar fashion to that described above for the calculation of matrix values. After the multiplication operation, there is a single matrix for each combination of angle, wavelength and polarization. These resulting elements can be manipulated to form complex reflection and/or transmission coefficients or to form reflectance, transmittance and/or absorbance coefficients. These can be used for further computation on the GPU or transferred to CPU memory for computation and/or further use.

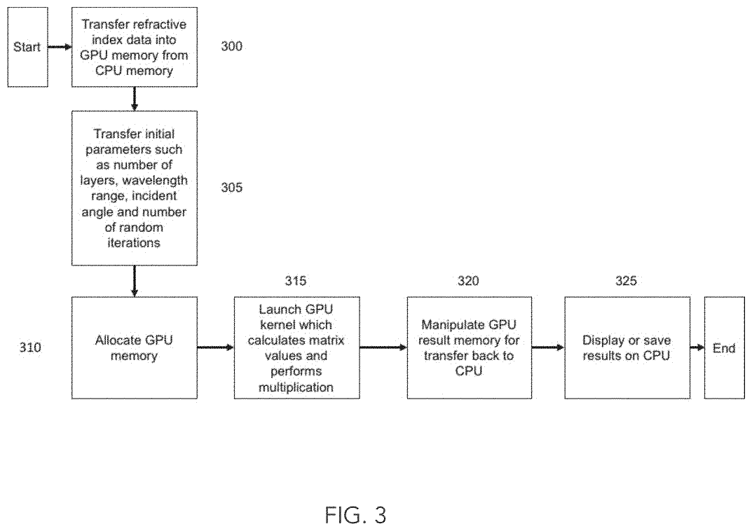

FIG. 3 illustrates an exemplary method, according to one or more embodiments, for a GPU-based thin film simulation. If one is to calculate a broadband reflectance function on the GPU, the range of wavelengths must be quantized and material data must be collated. For example, the reflectance from 400 nm to 1000 nm can be split into 1 nm increments, leading to 600 different wavelengths that are calculated separately. Material refractive indices at each of these wavelengths must be loaded into GPU memory 305. The other parameters of the film under test must also be loaded into GPU memory, such as the mapping of layers to materials, the number of layers, which wavelengths to be calculated, incident angle and polarizations of light. Once relevant data is in GPU memory, a kernel can be launched acting upon each of the unique combinations in parallel 315. Given the limited GPU memory, a set of matrices corresponding to unique wavelength, angle, material stack and polarization is calculated before the data is transferred to the CPU 320 and the next set of matrices can be calculated to get new results. Once the GPU calculations are over, the CPU can manipulate the data for further analysis if so desired 325.

As an example, the present invention can be implemented using the NVIDIA GeForce 1070Ti or similar GPU, which has 2432 cores. But the present system and method are not limited to this example and apply in general to many different types of GPUs. Each core can be assigned operations to compute so that the output of many cores provides, for example, a broadband reflectance function across a range of wavelengths. Traditional CPU computing would compute each wavelength sequentially, so as a result, the GPU achieves a significantly higher throughput for computation.

The present invention provides tangible improvements in calculation speed over the prior art. Such enhancements were not comprehended by the prior solutions to the present problem. In one test, an optimization of a 7-layer film, involving testing one hundred thousand random thickness combinations over a 600nm bandwidth (separated into reflectance every 1 nm) took 1 hour on an Intel Core-i5-6500 CPU running at 3.2GHz was completed in 1 second using an NVIDIA GeForce 1070Ti GPU in accordance with the present invention. This revolutionary improvement (˜3600×) in calculation speed enables the discovery of new film-stack solutions and time-saving computation of current film characteristics. For example, because thin-film simulation methods are not time-prohibitive when implemented on the GPU, one may perform a full manufacturing simulation with variations in each layer thickness as given by manufacturing error over millions of trials. This will allow development of more robust solutions that can fulfil the spectral requirements demanded of the coatings but are more tolerant to manufacturing errors. Again, the examples provided herein are merely exemplary and for the sake of illustration. The present invention will be appreciated by those skilled in the art to comprehend other implementations and examples just as well.

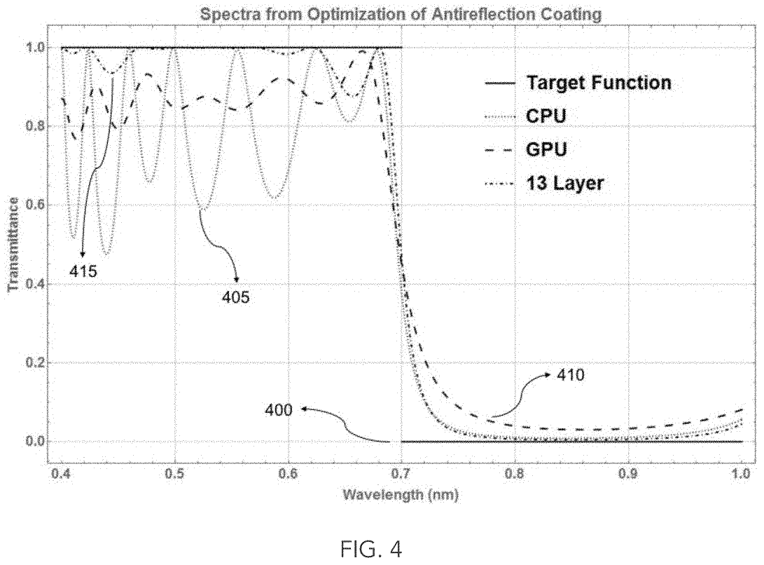

The present optimization process can be applied to a problem of developing a low number of layers antireflection coating over a specific wavelength range in an example solution. FIG. 4 illustrates a plot showing the relevant spectra. The target transmittance function 400 used in this example is one that has 100% transmission from 400nm to 700nm, and then 100% reflectance from 700nm to 1000nm. This could be useful in a coating that should only allow visible light to pass and reflect and near-infrared light at normal incidence, for example in an imaging application. An example film stack as shown in FIG. 1, with high-low alternating layers used and with air being the medium above and below the stack. The materials chosen are TiO2 for the high-refractive index material 105 and SiO2 for the low-refractive index material 110. We can solve the problem of what layer thicknesses in the stack match the target function described above. One method is to try many random solutions and choose the best of them. Another possible way of optimizing is to use a modified version of the Levenberg-Marquardt (LM) algorithm, which is used for many least-squares fitting problems. The optimization method used here involves developing a cost function which determines the relative “goodness-of-fit” of the current film stack relative to the target function.

Cost Function=Σ_{λ,θ, P}w(λ, θ, P) (T(λ, θ, P)−F(λ, θ, P))²

In this case, the squared difference between the target function and the film transmittance function over the relevant wavelength range is used as the “goodness-of-fit” parameter. Additionally, the squared difference can be weighted by an arbitrary function. An example of this is in the case of angle averaging, where α cos(θ) weighting scheme could be added. The goal is to find the set of film thicknesses \vec{t}={t₁, t₂, . . . , tₙ} so that the cost function is minimized.

Here, find \vec{t} so that min Σ_{λ, θ, P} w(λ, θ, P) (T(λ, θ, P)−F(λ, θ, P, \vec{t})²

The method used here is to randomly sample the thickness space \vec{t} and then choose the best few solutions and apply the modified LM algorithm to find a local minimum in the \vec{t} space. The modified LM algorithm perturbs each layer by recalculating the cost function value at +/−1 nm in thickness. It then changes the thickness of the layer based on the direction that reduces the cost function value the most. This process continues iteratively until a local minimum is found: increasing or reducing the layer thickness of any of the films would lead to an increase in the cost function value.

On the CPU, we compute 100,000 random solutions and then choose the best 100 and apply the modified LM algorithm to find the best solution 405 and the resulting film stack thicknesses are shown in 500. This took 1.5 hours on an Intel Core-i5-6500 CPU running at 3.2 GHz. The same process using an NVIDIA GeForce 1070Ti GPU took 4 seconds. If we instead run on the GPU at test of two million random solutions and choose the best 10000 to apply the modified LM algorithm, the result is strikingly better 410 with the resulting film stack thicknesses shown in 510. This took 7.5 minutes on the NVIDIA GeForce 1070Ti GPU, which would have taken 7 days on the CPU.

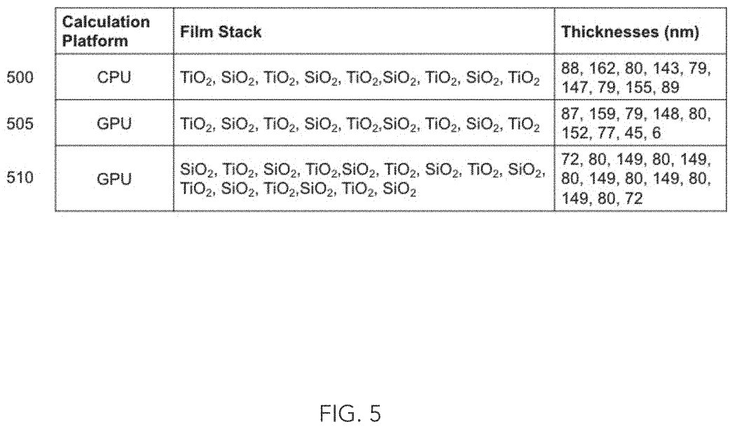

Because of the speed of the GPU-based algorithms, we can try different design techniques that would ordinarily be time prohibitive to implement and use. Keeping the high and low refractive index material design, it is not necessarily optimal to choose a 9-layer film for the alternating TiO2 and SiO2 stack. In principle, a different number of layers could yield a solution that comes closer to the target function. In an automated fashion, every combination of alternating high-low refractive index materials from 4 layers to 15 layers is tested using the same methodology as described above, with one million random solutions (different thicknesses for each layer) tried for each unique stack and the best one thousand solutions used for modified LM-based descent. The result is a 13-layer film 515 with function 415 that matches the target function better than that found by the previous method. This design method tested twenty-four million random solutions and ran 24000 iterative descents in 24 minutes. It is impractical to run this on the CPU, but the estimate would be that it would take approximately 250 days. The three solutions found by the three methods described above are shown in FIG. 5. The optimization methods detailed above are given as examples and do not represent the entirety of the set of optimization methods that could be used in conjunction with GPU-based computation of film characteristics. Other methods, include, but are not limited to, simulated annealing, Bayesian optimization, particle swarm optimization, etc.

GPU-based computation of film characteristics can also be used to improve the manufacturing of optical thin-films. Thin-film deposition machines often have variability in the deposition rate of a given material. Real-time monitoring of the film characteristics, such as reflection profile, is often done using a spectrometer. Given the extensive simulation power of GPU-based techniques, the measured spectra can be used to guess the most likely “true” film thickness, thereby creating a feedback loop where the variability in deposition rate is less of an issue. Powerful statistical techniques can be applied to correct for the “compacting” of films, a phenomenon whereby depositing a material on top of a previously deposited material “compacts” the lower material, making it effectively thinner. By simulating the possibility space and using measured spectral data to find the most likely film, an active feedback loop can be created which improves the quality and yield of films.

The true refractive index of a material may not be perfectly known. GPU-based simulation can find the most likely true refractive index by simulating millions of refractive index combinations and comparing to the measured spectra. In this embodiment, spectral monitoring combined with GPU-based simulation can be used to determine the refractive index of a material or film.

In one or more embodiments, birefringent films may be used in liquid crystal displays (LCD) to control display intensity via rotation of polarization. New birefringent film designs are possible using the present system and method, provide significantly higher throughput for computation, which could enable the design of new birefringent films.

The present system and method can be extended to capture the magnetic properties as well as electric film properties. For example, a 4×4 formulation of the present TMM solves for both electric field and magnetic field, enabling the calculation of a more complete set of film properties in the case that layer materials are magnetic. This can be used to design new multilayer structures with unique magnetic and electric properties. When made amenable to GPU-based computation, these methods could be used to discover new magneto-optic films which are used, for example, in storage devices such as hard drives.

Strongly scattering materials within a film stack create phenomena that is not captured in the TMM described above. These can effects can be approximated by modifying the TMM to include factors that account for the loss of coherence through a material. By combining the propagation of waves in thick films with the propagation in thin films, it is possible to estimate the characteristics of a thick multilayer sample comprising of rough boundaries, thin films, and thick materials with incoherent electric field propagation. The present GPU structure used for 2×2 matrices (as an example) can still be utilized with the addition of constants and calculation related to strong scattering phenomena and incoherent propagation of electric field through thick films to significantly increase the speed of computation for prediction and design of these types of films.

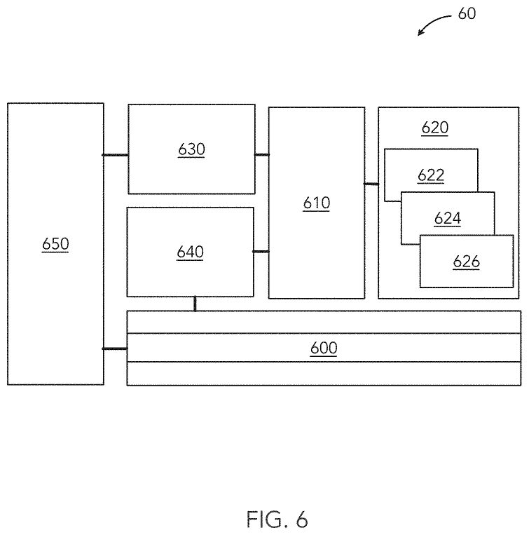

FIG. 6 illustrates a system 60 for designing, characterizing or studying a thin film stack 600 according to this invention.

The system includes a graphics processing unit (GPU) including a plurality of cores 622, 624, 626, each capable and designed to simultaneously execute in parallel a set of appropriate machine-readable instructions. Optionally, a central processing unit (CPU) 610 may be coupled to and cooperate with said GPU. For example, the CPU may execute an operating system of a computer or server device, and may direct the operations of a real-time controller 630 of a film deposition apparatus 650 that is configured to sequentially deposit films onto said thin film stack 600. The CPU may also receive measurements from a refractometer or other measurement device 640. These components and others can be implemented in a variety of ways appreciated by those skilled in the art, and not all components described here are required in every embodiment, nor are the components necessarily connected in the simplified way presented here for illustration.

Those skilled in the art will appreciate many advantages of the present invention(s) and disclosure in solving problems of the prior art in the present field. As described and claimed, this disclosure provides a method for parsing, processing and/or displaying relevant market information in the field of managing financial instruments and choosing plans such as retirement plans. The current state of the art is rife with inconsistent and inaccurate decision making, inadequate due diligence results, and other variations in handling financial planning and retirement fund choice activities. The state of the art technology, hardware, software, data repositories and user interfaces are incapable of carrying out the presently-disclosed methods and inventions.

User interface modules and components are also optionally included in the present system to enable a user (e.g., engineer or customer) to optimize or verify the nature of a wide variety of thin film stacks. The present method for automated review, processing, manipulating and generating data using the present hardware components and auxiliary film deposition machinery.

Thus, the present disclosure and claims include new and novel improvements to existing methods and technologies, which were not previously known nor implemented to achieve the useful results described above. Users of the present method and system will reap tangible benefits from the functions now made possible on account of the specific modifications described herein causing the effects in the system and its outputs to its users. It is expected that significantly improved operations can be achieved upon implementation of the claimed invention, using the technical components recited herein, insofar as design, optimization, characterization, testing and study of optical, magnetic, acoustical and other multi-layered systems is enabled hereby. The functions of the present system and the steps of this method can drastically improve the economy and performance of systems in this field of art, and such improvements are directly a result of this new architecture and method. The functionality available by this invention, which overcomes problems in the present field, is directly attributable to the present technical modifications and innovations to a data processing system and architecture, including to its processors, programmed instruction sets, data storage and user interface elements.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

It should be understood that the features disclosed herein can be used in any combination or configuration. Thus, for example, in some embodiments, any one or more of the features disclosed herein may be used without any one or more other feature disclosed herein.

Unless stated otherwise, a processing device or system is any type of device that includes at least one processor, and in various preferred embodiments may include many-core or many-processor circuits in a processing architecture such as the described GPU arrangement lending itself to parallel computations at the same time on the many processing circuits or cores.

Unless stated otherwise, a processor may comprise any type of processor. For example, a processor may be programmable or non-programmable, general purpose or special purpose, dedicated or non-dedicated, distributed or non-distributed, shared or not shared, and/or any combination thereof. A processor may include, but is not limited to, hardware, software (e.g., low-level language code, high-level language code, microcode), firmware, and/or any combination thereof.

Unless stated otherwise, a program may include, but is not limited to, instructions in a high-level language, low-level language, machine language and/or other type of language or combination thereof.

Unless stated otherwise, a communication link may comprise any type(s) of communication link(s), for example, but not limited to, wired links (e.g., conductors, fiber optic cables) or wireless links (e.g., acoustic links, radio links, microwave links, satellite links, infrared links or other electromagnetic links) or any combination thereof, each of which may be public and/or private, dedicated and/or shared. In some embodiments, a communication link may employ a protocol or combination of protocols including, for example, but not limited to the Internet Protocol.

Unless stated otherwise, information may include data and/or any other type of information. This information and data may be encoded into corresponding electrical, electronic, optical, magnetic, or other suitable physical signals. The encoded signals representing the information and data can then be stored in the above-mentioned data stores, which may be directly or indirectly coupled to the processing machinery of the invention. The components of the present system may be inter-connected over wired or wireless communication channels including local area networks, wide area networks, or the internet, using a communication link.

Furthermore, one skilled in the art will readily appreciate that applications not explicitly exemplified are not beyond the scope of the present invention. For example, dichroic filters are used in one or more embodiments, but other optical filters are not beyond the scope of the present invention, such as, interference, absorption, diffraction, grating, Fabry-Perot, etc. An interference filter consists of multiple thin layers of dielectric material having different refractive indices. There also may be metallic layers. In its broadest meaning, interference filters comprise also etalons that could be implemented as tunable interference filters. Interference filters are wavelength-selective by virtue of the interference effects that take place between the incident and reflected waves at the thin-film boundaries.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein.

Those skilled in the art will recognize or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments may be implemented in any of numerous ways. One or more aspects and embodiments of the present application involving the performance of processes or methods may utilize program instructions executable by a device (e.g., a computer, a processor, or other device) to perform, or control performance of, the processes or methods.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above.

The computer readable medium or media may be transportable, such that the program or programs stored thereon may be loaded onto one or more different computers or other processors to implement various ones of the aspects described above. In some embodiments, computer readable media may be non-transitory media.

The terms “program” or “software” are used herein in a generic sense to refer to any type of computer code or set of computer-executable instructions that may be employed to program a computer or other processor to implement various aspects as described above. Additionally, it should be appreciated that according to one aspect, one or more computer programs that when executed perform methods of the present application need not reside on a single computer or processor but may be distributed in a modular fashion among a number of different computers or processors to implement various aspects of the present application.

Computer-executable instructions may be in many forms, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a personal digital assistant (PDA), a smart phone, a mobile phone, an iPad, or any other suitable portable or fixed electronic device.

Also, a computer may have one or more input and output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined.

Elements other than those specifically identified by the “and/or” clause may optionally be present, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, the term “between” is to be inclusive unless indicated otherwise. For example, “between A and B” includes A and B unless indicated otherwise.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The present invention should therefore not be considered limited to the particular embodiments described above. Various modifications, equivalent processes, as well as numerous structures to which the present invention may be applicable, will be readily apparent to those skilled in the art to which the present invention is directed upon review of the present disclosure.

What is claimed is:

1. A method for characterizing a multi-layer thin film stack using parallel processing computations in a multi-core graphics processing unit (GPU), the method comprising:
loading a plurality of data sets into respective memory locations of a data store, each data set corresponding to a layer of said multi-layer thin film stack, said plurality of data sets including data corresponding to respective material properties of said layers and further including data corresponding to respective geometric parameters of said layers;
executing in parallel, in each of a plurality of said GPU cores, machine-readable instructions encoding a transfer matrix method (TMM), and taking as inputs said plurality of data sets; and
using said GPU cores to generate outputs corresponding to one or more characteristics of said thin film stack.

2. The method of claim 1, said material properties comprising respective electromagnetic properties of each of said layers.

3. The method of claim 1, said material properties comprising respective optical properties of each of said layers.

4. The method of claim 1, said material properties comprising respectively, for each of said layers, at least one of: density, impedance, refractive index, dielectric constants, magnetic permeability, and a speed of a wave in said respective layer.

5. The method of claim 1, said geometric parameters comprising a respective thickness of each of said layers.

6. The method of claim 1, said TMM method comprising representing each of said layers by a matrix and performing a matrix multiplication process executed in said GPU cores.

7. The method of claim 1, said plurality of data sets comprises at least one of: an angle, a wavelength, and a polarization parameter.

8. The method of claim 7, wherein said S and P polarizations are computed on separate cores of said GPU.

9. The method of claim 1, further comprising providing the respective outputs of said GPU cores to a central processing unit (CPU).

10. The method of claim 1, further comprising executing an optimization program to arrive at a set of parameters of said layers based on a desired input film stack characteristic.

11. The method of claim 1, further comprising computing in said GPU cores a matrix representing a respective magnetic field in each of said layers.

12. The method of claim 1, further comprising computing in said GPU cores a matrix representing a respective electric field in each of said layers.

13. The method of claim 1, further comprising computing in said GPU cores a matrix representing a respective Poynting vector in each of said layers.

14. The method of claim 1, further comprising sequentially depositing layers onto said thin film stack, and further comprising computing the characteristics of said thin film stack following deposition of each new layer onto said stack.

15. The method of claim 1, said parallel execution comprising simultaneously executing, in each separate core of said GPU, an output corresponding to a different angle of incidence of radiation onto a surface of said film stack.

16. The method of claim 1, said parallel execution comprising simultaneously executing, in each separate core of said GPU, an output corresponding to a different wavelength of radiation onto a surface of said film stack.

17. The method of claim 1, said output comprising at least one of: a complex reflection, transmission, reflectance, transmittance, and absorption coefficients.

18. A system for automated characterization of a multi-layered thin film stack, comprising:
a graphics processing unit (GPU) having a plurality of processor cores each configured and arranged to execute machine-readable instructions in parallel;
a data store, coupled to said GPU, having addressable storage locations encoding parameters describing a plurality of individual films in said film stack; and
a feedback controller configured and arranged to control a layer deposition process that adds layers to said film stack.

19. The system of claim 18, further comprising a refractometer that determines a characteristic of said film stack and provides and output representing said characteristic.

20. The system of claim 19, further comprising a central processing unit (CPU) coupled to said GPU and refractometer and configured and arranged to control said feedback controller based on real-time measurements by said refractometer.
